(19) United States
(12) Patent Application Publication
(10) Pub. No.: US 2025/0359703 A1
(43) Pub. Date: Nov. 27, 2025

(54) COLLAPSIBLE BARBECUE

(71) Applicant: HITCH A DEAL PTY LTD, Wangara (AU)

(72) Inventor: Gert Johannes Van Der Westhuizen, Wangara (AU)

(73) Assignee: HITCH A DEAL PTY LTD, Wangara (AU)

(21) Appl. No.: 18/875,145

(22) PCT Filed: Jun. 13, 2023
(86) PCT No.: PCT/AU2023/050519

§ 371 Date: Dec. 14, 2024

(30) Foreign Application Priority Data
Jun. 14, 2022 (AU) 2022901618

(51) Int. Cl. A47J 37/07

(52) U.S. Cl. CPC A47J 37/0763; A47J 37/0704; A47J 2037/0777

(57) ABSTRACT

Provided is a collapsible barbecue (10) comprising two leg panels (12) each defining a complementary diagonal keyhole slot (14) therein, a gridiron or grill (16), and a holder arrangement (18) for operatively holding a thermal energy source. The holder arrangement (18) comprises a quadrilateral frame (20) with each leg panel (12) hingedly arranged on an opposed side 22.1 and the gridiron or grill (16) hingedly arranged on a transverse side 22.2 of the frame (20). The two side panels (24) are each hingedly arranged at a transverse side 22.2 of the frame (20), with a floor panel (26) hingedly fast with each side panel (24) distal from the frame (20) to form a floor of the holder arrangement (18). One floor panel hinge 28 defines an extending head (30) at either ends of said hinge. In this manner, the barbecue (10) is arrangeable between an assembled position, in which the leg panels (12) are substantially parallel and upright with the extending heads (30) of the floor panel hinge (28) captured within the respective keyhole slots (14) and the frame 20 and floor panel (26) of the holder arrangement (18) being substantially horizontal, and a collapsed position, in which the leg panels (12), gridiron or grill (16), quadrilateral frame (20), side panels (24) and floor panel (26) are hinged onto each other to lie substantially coterminous.

### TECHNICAL FIELD

This invention relates broadly to the field of food preparation and more specifically to a collapsible barbecue.

### BACKGROUND ART

The following discussion of the background art is intended to facilitate an understanding of the present invention only. The discussion is not an acknowledgement or admission that any of the material referred to is or was part of the common general knowledge as at the priority date of the application.

Barbecue or barbeque (informally BBQ in the UK and US, ‘barbie’ in Australia and ‘braai’ in South Africa) is a term used with various regional and national variations to describe cooking methods which use live fire and/or smoke to cook food. The term is also generally applied to the devices associated with those methods, the broader cuisines that these methods produce, and the meals or gatherings at which this style of food is cooked and served.

Applicant has identified a need in the art for a sturdy yet compact and easily-transportable barbecue which allows a user to prepare barbecued food using wood, charcoal and/or gas.

The current invention was conceived with these goals in mind.

### SUMMARY OF THE INVENTION

According to an aspect of the invention there is provided a collapsible barbecue comprising:
two leg panels each defining a complementary and corresponding diagonal keyhole slot therein;
a gridiron or grill; and
a holder arrangement for operatively holding a thermal energy source, said holder arrangement comprising:
   i. a quadrilateral frame with each leg panel hingedly arranged on an opposed side and the gridiron or grill hingedly arranged on a transverse side;
   ii. two side panels each hingedly arranged at a transverse side of the frame; and
   iii. a floor panel hingedly fast with each side panel distal from the frame to form a floor of the holder arrangement, one such floor panel hinge defining an extending head at either ends of said hinge;
      wherein the barbecue is arrangeable between an assembled position, in which the leg panels are substantially parallel and upright with the extending heads of the floor panel hinge captured within the respective keyhole slots and the frame and floor panel of the holder arrangement being substantially horizontal, and a collapsed position, in which the leg panels, gridiron or grill, quadrilateral frame, side panels and floor panel are hinged onto each other to lie substantially coterminous.

In an embodiment, the collapsible barbecue includes a cover shaped and dimensioned to fit over the frame to cover the holder arrangement in the assembled position, or to receive the leg panels therein to form a base for the collapsible barbecue in the assembled position.

Typically, the cover is shaped and dimensioned to receive the barbecue therein when in the collapsed position.

In an embodiment, the thermal energy source may comprise wood, charcoal and/or gas.

In an embodiment, the holder arrangement includes a gas burner.

In an embodiment, the holder arrangement defines a bracket for receiving and positioning a gas burner therein.

In an embodiment, the leg panels, gridiron or grill, quadrilateral frame, side panels and floor panel are manufactured from stainless steel.

In an embodiment, the leg panels each define a flange at a lower end thereof to form footing for the barbecue when in the assembled position.

In an embodiment, the leg, side and/or floor panels define airflow apertures to facilitate combustion of combustible material as the thermal energy source.

According to a further aspect of the invention there is provided a collapsible barbecue substantially as herein described and/or illustrated.

### BRIEF DESCRIPTION OF THE DRAWINGS

The description will be made with reference to the accompanying drawings in which:

FIG. 1 is a diagrammatic perspective view representation of an embodiment of a collapsible barbecue, in accordance with an aspect of the present invention;

FIG. 2 is a diagrammatic side-view representation of the collapsible barbecue of FIG. 1;

FIG. 3 is diagrammatic perspective exploded view representation of the collapsible barbecue of FIG. 1;

FIG. 4 is a diagrammatic front-view representation of the collapsible barbecue of FIG. 1;

FIG. 5 is a diagrammatic front view representation of the collapsible barbecue of FIG. 4, showing leg panels being arranged from an assembled position to a collapsed position;

FIG. 6 is a diagrammatic side-view representation of the collapsible barbecue of FIG. 5, with a holder arrangement in an assembled position; and

FIG. 7 is a diagrammatic side-view representation of the collapsible barbecue of FIG. 6, showing the holder arrangement arranged into a collapsed position.

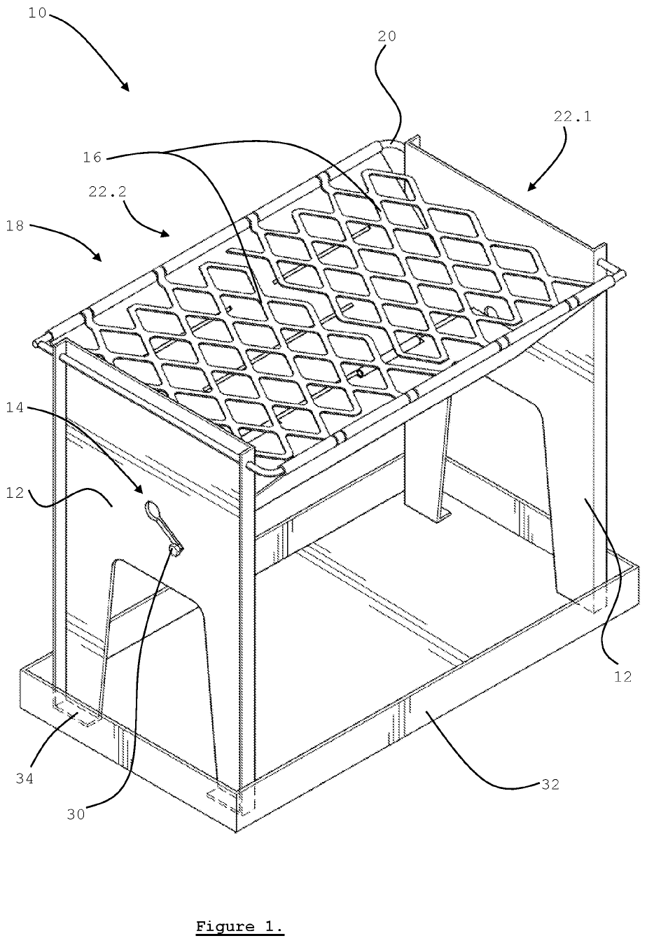

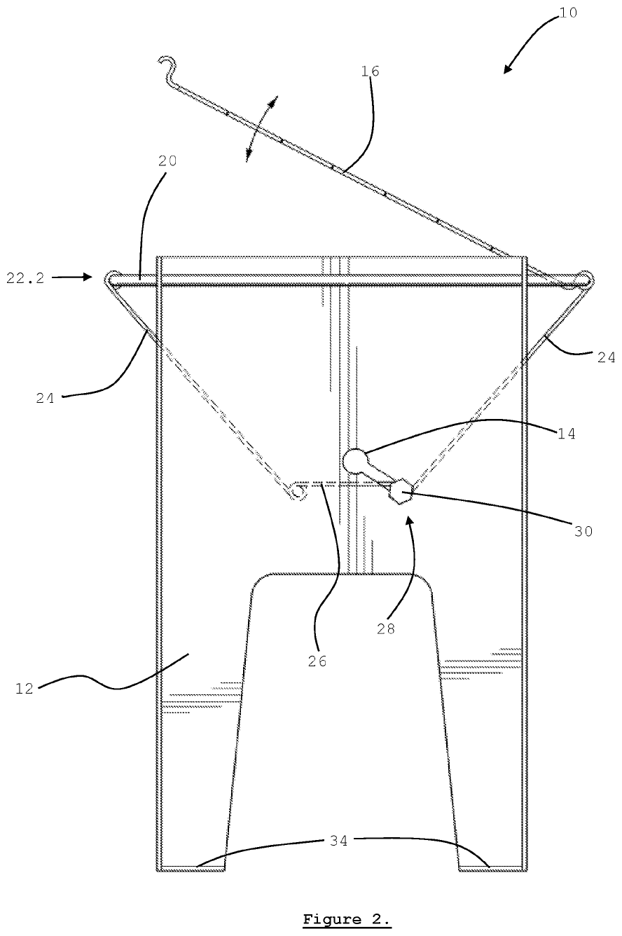

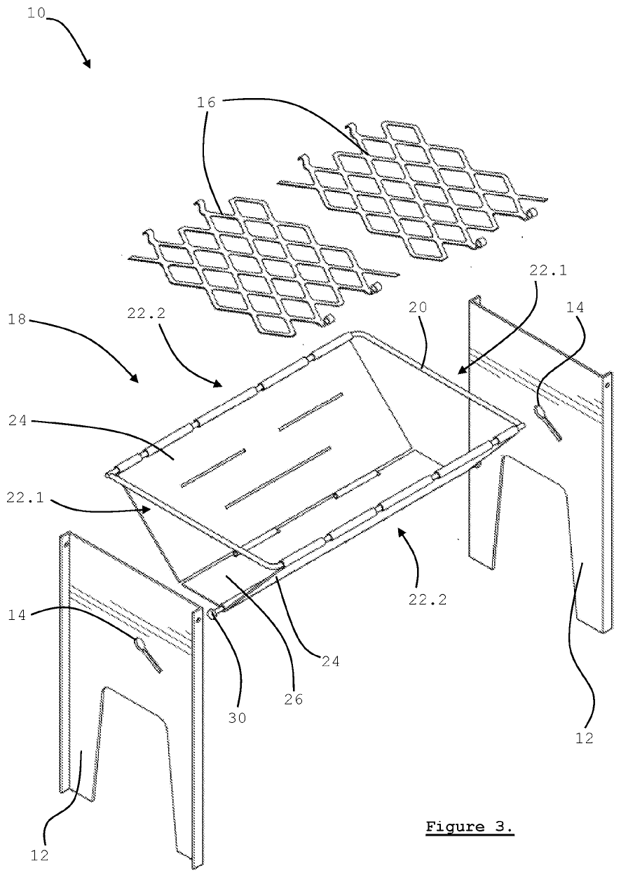

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above.

In the figures, incorporated to illustrate features of the example embodiment or embodiments, like reference numerals are used to identify like parts throughout. Additionally, features, mechanisms and aspects well-known and understood in the art will not be described in detail, as such features, mechanisms and aspects will be within the understanding of the skilled addressee.

Broadly, the present invention provides for a sturdy yet compact and easily-transportable collapsible barbecue 10 which allows a user to prepare barbecued food using wood, charcoal and/or gas. Broadly, the collapsible barbecue 10 comprises leg panels 12, a holder arrangement 18, a gridiron or grill 16 and an optional cover 32.

With reference now to the accompanying figures, there is shown one embodiment of the collapsible barbecue 10. Collapsible barbecue 10 generally includes two leg panels 12, each defining a complementary and corresponding diagonal keyhole slot 14 therein, as shown. The diagonal keyhole slots 14 are specifically positioned on each leg panel 12 in order to facilitate an arranging the barbecue 10 in either assembled position or a collapsed position, as described below. In an embodiment, the leg panels 12 each define a flange 34 at a lower end thereof to form footing for the barbecue 10 when in the assembled position.

Barbecue 10 also includes a gridiron or grill 16, which may be comprised of separate gridiron sections or a single gridiron, requirements depending. As known in the art, such a gridiron or grill 16 comprises any suitable manner of grated implement useable to position food over a heat source, such as a fire.

Barbecue 10 also includes a holder arrangement 18 for operatively holding a thermal energy source, such as wood, charcoal and/or gas. Typically, the holder arrangement 18 comprises a quadrilateral frame 20 with each leg panel 12 hingedly arranged on an opposed side 22.1 and the gridiron or grill 16 hingedly arranged on a transverse side 22.2, as shown.

The holder arrangement 18 further comprises two side panels 24 that are each hingedly arranged at a transverse side 22.2 of the frame 20, as well as a floor panel 26 which is hingedly fast with each side panel 24 distal from the frame 20 to form a floor of the holder arrangement 18, as shown. As indicated, the side panels 24 are typically diagonal when the barbecue is in the assembled position. Importantly, one of the floor panel hinges defines an extending head 30 at either ends of said hinge 28. These extending heads 30 engage with the keyhole slots 14 in the leg panels 12, as described below.

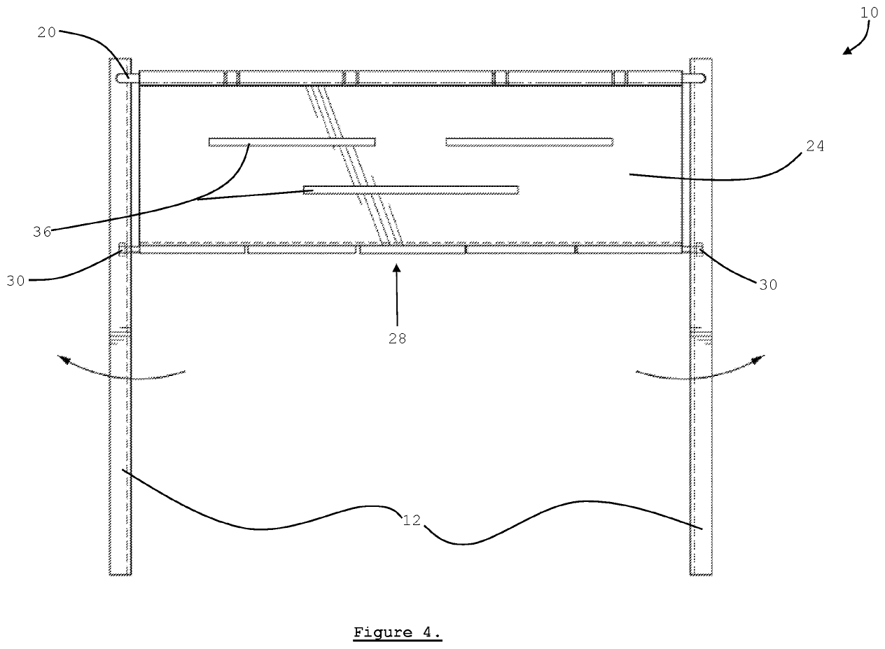

In this manner, the barbecue 10 is arrangeable between an assembled position, in which the leg panels 12 are substantially parallel and upright with the extending heads 30 of the floor panel hinge 28 captured within the respective keyhole slots 14 and the frame 20 and floor panel 26 of the holder arrangement 18 being substantially horizontal, and a collapsed position, in which the leg panels 12, gridiron or grill 16, quadrilateral frame 20, side panels 24 and floor panel 26 are hinged onto each other to lie substantially coterminous. FIGS. 4 to 7 shows the transformation of the barbecue 10 from the assembled position to the collapsed position.

As shown, when in the assembled position, the specific configuration of the leg panels 12 with diagonal keyhole slots 14 as hinged to the frame 20, with the complementary configuration of the holder arrangement 18 suspended from the frame 20, having the specific side and floor panels 24 and 26, allows the extending heads 30 to be captured within the keyhole slots 14 so that the barbecue is essentially locked into position in the assembled position.

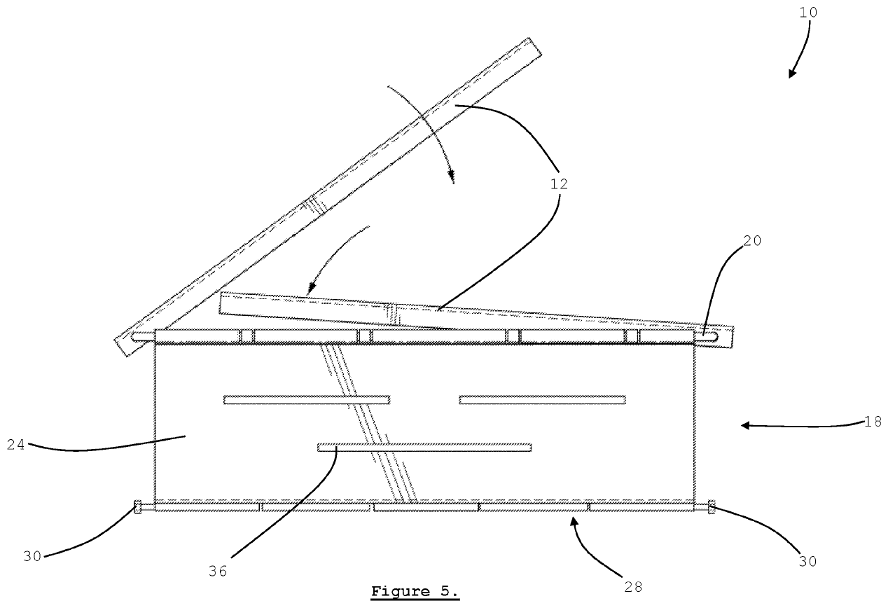

Similarly, when arranged into the collapsed position, the side and floor panels 24 and 26 are manipulable so that the extending heads 30 are released from the keyhole slots 14, allowing the leg panels 12 to hinge outward and onto the frame 20 and gridiron 16, as shown in FIGS. 4 and 5.

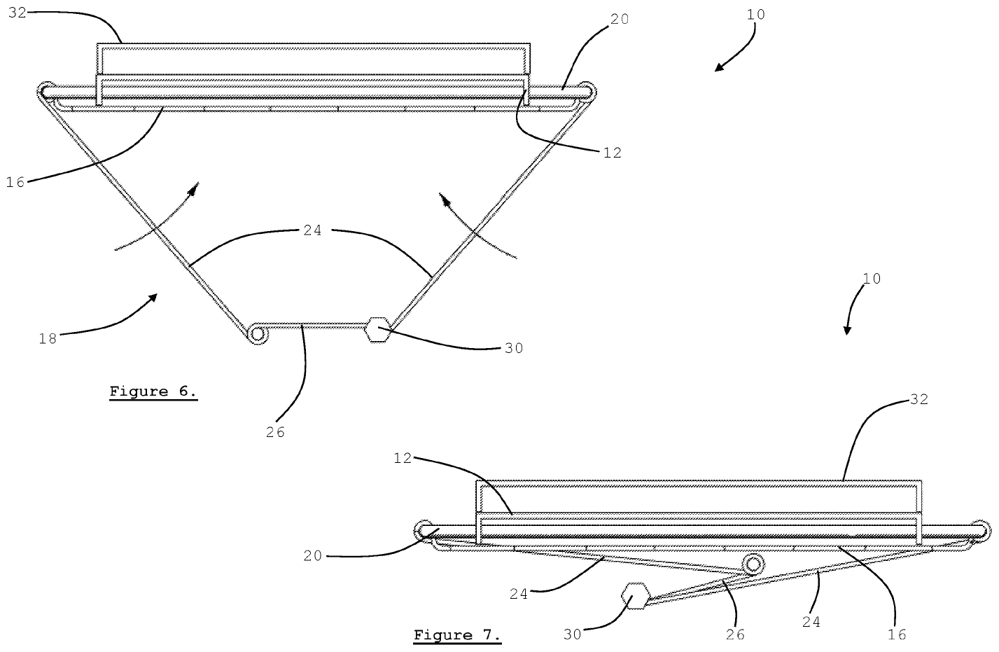

Once the leg panels 12 are hinged in this manner, the side and floor panels 24 and 26 are hingeable onto themselves, as shown in FIGS. 6 and 7, so that the respective side and floor panels 24 and 26 fold onto themselves towards the frame 20, effectively collapsing the holder arrangement 18. Once collapsed, the leg panels 12, gridiron or grill 16, quadrilateral frame 20, side panels 24 and floor panel 26 are hinged onto each other to lie substantially coterminous, as shown.

In one embodiment, the collapsible barbecue 10 includes a cover 32 which is shaped and dimensioned to fit over the frame 20 to cover the holder arrangement 18 in the assembled position, or to receive the leg panels 12 therein to form a base for the collapsible barbecue in the assembled position. The cover 32 is useful in cooking food, such as to contain heat and/or smoke, or to act as a base for the barbecue 10 to catch falling embers or coals, or the like. In one embodiment, the cover 32 is also typically shaped and dimensioned to receive the barbecue therein when in the collapsed position, i.e. to act as a container for the collapsed barbecue to facilitate storage and portability.

In embodiment, the holder arrangement 18 receives combustible materials therein, in use, such as wood, charcoal, briquettes, or the like, to serve as a thermal energy source for cooking purposes. In another embodiment, the barbecue may include a gas burner (not shown), or may be configured to receive a gas burner as the thermal energy source. For example, in an embodiment, the holder arrangement 18 may define a bracket or the like for receiving and positioning a gas burner therein to facilitate cooking. In an embodiment, the leg, side and/or floor panels may define airflow apertures 36 to facilitate combustion of combustible material as the thermal energy source.

In a typical embodiment, the leg panels 12, gridiron or grill 16, quadrilateral frame 20, side panels 24 and floor panel 26 are manufactured from stainless steel. The skilled addressee is to appreciate, however, that variations hereon are possible and expected and included within the scope of the present invention.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth. In the example embodiments, well-known processes, well-known device structures, and well-known technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It is to be appreciated that reference to “one example” or “an example” f the invention, or similar exemplary language (e.g., “such as”) herein, is not made in an exclusive sense. Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise. Variations, modifications and/or enhancements of one or more embodiments described herein might become apparent to those of ordinary skill in the art upon reading this application. The inventor(s) expects skilled artisans to employ such variations as appropriate, and the inventor(s) intends for the claimed subject matter to be practiced other than as specifically described herein.

1. A collapsible barbecue comprising:
two leg panels each defining a complementary and corresponding diagonal keyhole slot therein;
a gridiron or grill; and
a holder arrangement for operatively holding a thermal energy source, said holder arrangement comprising:
i. a quadrilateral frame with each leg panel hingedly arranged on an opposed side and the gridiron or grill hingedly arranged on a transverse side;
ii. two side panels each hingedly arranged at a transverse side of the frame; and
iii. a floor panel hingedly fast with each side panel distal from the frame to form a floor of the holder arrangement, one such floor panel hinge defining an extending head at either ends of said hinge;
wherein the barbecue is arrangeable between an assembled position, in which the leg panels are substantially parallel and upright with the extending heads of the floor panel hinge captured within the respective keyhole slots and the frame and floor panel of the holder arrangement being substantially horizontal, and a collapsed position, in which the leg panels, gridiron or grill, quadrilateral frame, side panels and floor panel are hinged onto each other to lie substantially coterminous.

2. The collapsible barbecue of claim 1, which includes a cover shaped and dimensioned to fit over the frame to cover the holder arrangement in the assembled position, or to receive the leg panels therein to form a base for the collapsible barbecue in the assembled position.

3. The collapsible barbecue of claim 2, wherein the cover is shaped and dimensioned to receive the barbecue therein when in the collapsed position.

4. The collapsible barbecue of claim 1, wherein the thermal energy source is selectable from wood, charcoal and/or gas.

5. The collapsible barbecue of claim 1, wherein the holder arrangement includes a gas burner.

6. The collapsible barbecue of claim 1, wherein the holder arrangement defines a bracket for receiving and positioning a gas burner therein.

7. The collapsible barbecue of claim 1, wherein the leg panels, gridiron or grill, quadrilateral frame, side panels and floor panel are manufactured from stainless steel.

8. The collapsible barbecue of claim 1, wherein the leg panels each define a flange at a lower end thereof to form footing for the barbecue when in the assembled position.

9. The collapsible barbecue of claim 1, wherein the leg, side and/or floor panels define airflow apertures to facilitate combustion of combustible material as the thermal energy source.
